(19) United States
(12) Patent Application Publication
(10) Pub. No.: US 2026/0225962 A1
(43) Pub. Date: Aug. 6, 2026

(54) SYSTEMS AND METHODS FOR MANUFACTURING CALCINED GYPSUM AND MANUFACTURING GYPSUM BOARD WITH MATERIAL HANDLING CHUTE HAVING IN-LINE MEASUREMENT DEVICE

(71) Applicant: United States Gypsum Company, Chicago, IL (US)

(72) Inventors: Blair C. Walker, Almonte (CA); Dayakar Thoddu Chandrasekaran, Lake Bluff, IL (US)

(73) Assignee: United States Gypsum Company, Chicago, IL (US)

(21) Appl. No.: 19/451,901

(22) Filed: Jan. 16, 2026

Related U.S. Application Data
(60) Provisional application No. 63/753,276, filed on Feb. 3, 2025.

(51) Int. Cl. C04B 40/00; B28B 19/00; C04B 11/028; G01N 21/3554; G01N 23/20; G01N 23/223; C04B 111/00

(52) U.S. Cl. CPC C04B 40/0032; B28B 19/0092; C04B 11/028; G01N 21/3554; G01N 23/20; G01N 23/223; C04B 2111/0062

(57) ABSTRACT

Embodiments of a system and a method for manufacturing calcined gypsum and for manufacturing a gypsum board can include a material handling chute assembly with a chute and an analyzer configured to analyze at least one characteristic of the material passing through the chute. The material handling chute assembly includes a chute, a funnel assembly configured to define a converging sample passage disposed within the interior passage of the chute, and an analyzer configured to analyze at least one characteristic of the material passing through the sample passage of the funnel assembly in the chute.

### CROSS-REFERENCE TO RELATED APPLICATION

This patent application claims the benefit of priority to U.S. Provisional Patent Application No. 63/753,276, filed February 3, 2025, and entitled, “Systems and Methods for Manufacturing Calcined Gypsum and Manufacturing Gypsum Board with Material Handling Chute Having In-Line Measurement Device,” which is incorporated in its entirety herein by this reference.

### BACKGROUND

The present disclosure relates to material handling chutes and systems and methods for calcining gypsum and for manufacturing gypsum board, such as, e.g., in continuous cementitious board manufacturing processes, and, more particularly, to systems and methods for calcining gypsum and manufacturing gypsum board which include a material handling chute with an in-line measurement device adapted to measure at least one of combined water and free moisture of gypsum and, preferably, to control at least one operating parameter based upon a signal received from the in-line measurement device.

Calcium sulfate materials are available in several forms or phases that are simplified as follows: calcium sulfate dihydrate—CaSO₄∙2H₂O (commonly known as gypsum); calcium sulfate hemihydrate—CaSO₄∙½H₂O (commonly known as stucco); and calcium sulfate—CaSO₄ (commonly known as anhydrite). In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Patent No. 5,320,677, for example. Typically, such gypsum-containing cementitious products are made by preparing a mixture of calcined gypsum (comprising calcium sulfate hemihydrate alpha or beta and/or calcium sulfate anhydrite), water, and other components, as appropriate to form cementitious slurry. The cementitious slurry and desired additives are often blended in a continuous mixer, as described in U.S. Patent No. 3,359,146, for example.

The mixture typically is cast into a pre-determined shape or onto the surface of a substrate. The calcined gypsum reacts with the water to form a matrix of crystalline hydrated gypsum, i.e., calcium sulfate dihydrate. It is the desired hydration of calcined gypsum that enables the formation of an interlocking matrix of set gypsum, thereby imparting strength to the gypsum structure in the gypsum-containing product.

Calcined gypsum is typically made by crushing gypsum rock to form land plaster and then heating the gypsum at atmospheric pressure to calcine (dehydrate) the calcium sulfate dihydrate into preferably calcium sulfate hemihydrate. In addition to natural gypsum rock, the use of synthetic gypsum, such as, e.g., flue gas desulphurization gypsum or gypsum from chemical processes can be used as well. The calcining of gypsum typically occurs in a large atmospheric pressure kettle containing a mixture of the various phases of the gypsum.

When gypsum, (i.e., calcium sulfate dihydrate) is calcined, water is removed from the calcium sulfate molecular structure. When one and a half molecules of water are removed from the molecular structure of gypsum, the hemihydrate results, a material used in various compositions in which rehydration occurs during the setting process subsequent to the addition of the water. When two molecules of water are removed from the molecular structure of gypsum, the anhydrite results. Anhydrites formed by calcining at low temperatures are able to rehydrate when exposed to moist conditions. However, if the calcium sulfate is calcined at high temperatures, typically of about 900° F or more, an insoluble form of calcium sulfate results.

For example, gypsum (CaSO₄∙2H₂O) powder, which can be referred to as “land plaster” and can come from sources such as rocks of natural gypsum crushed to make gypsum powder or synthetic gypsum made to be a powder, is heated to calcine into stucco, such as by being heated to a temperature of generally about 250° F–360° F. With appropriate thermal energy, the gypsum powder converts to hemihydrate (CaSO₄∙½H₂O). If the hemihydrate is exposed to even greater thermal energy, the gypsum can convert to soluble anhydrite (CaSO₄) or insoluble anhydrite (often referred to as “dead burn”). At great enough exposure to thermal energy, some of the CaSO₄ converts to CaO (quicklime), giving the dead burn a higher pH. When calcining gypsum via a process reactor, the primary control mechanism to maintain quality is typically to maintain a material (e.g., stucco) output temperature, of which the material feed to the calciner and/or the heat to the calciner is manipulated to maintain the calciner output control.

The quality of calcined gypsum can be measured in many ways. For example, a manual gravimetric method can be used to measure the amount of crystal combined water in the material sample to provide an indication of the degree of material calcination that occurred. This measure of the degree of calcination can then be used to infer the general phase composition of the calcined gypsum. As a related example, a series of manual gravimetric tests of calcined gypsum that has been hydrated and heated for different periods of time can be used to produce a calculated phase composition of the calcined gypsum.

As another example, thermal temperature profiles of samples of calcined gypsum mixed with water are manually monitored, measured, and analyzed. The water and calcined gypsum produce an exothermic reaction where different temperature rates can be calculated to provide a phase composition of the calcined gypsum.

Stucco phase manual measurements are periodic and off-line, requiring a period of time for laboratory testing. The manual nature of testing limits the frequency of testing, of which there are periods of time where quality is unknown. Furthermore, when tested, there is a lag in results, both of which limit the capability to control the calcination process and board formation.

As yet another example, near infrared (NIR) equipment can be used to measure the amount of crystal combined water in land plaster and calcined gypsum. The equipment can be used manually or in an inline process (such as is described in International Patent Application No. WO 2018/091062 A1). However, prior in-line NIR arrangements have been prone to build up of material, which leads to the fouling of the analyzer and/or include an analyzer arranged with a moving horizontal belt or screw operated to transport the material past the analyzer. Such arrangements can be difficult to maintain and require additional expenditures to operate.

Prior arrangements of an NIR analyzer in a chute have had the NIR analyzer mounted to the side of the chute. Material often does not fall evenly through the chute past the analyzer lens in the chute wall, resulting in surging or low-density material and yielding poor and inconsistent readings from the analyzer.

Prior arrangements of an NIR analyzer in a chute have included a “snorkel” aid associated with the NIR analyzer. The snorkel aid is an extension added to the analyzer which is inserted through a chute wall and positioned to reach an internal area of the chute. On the end of the snorkel is a cup that can catch and hold material for the analyzer to get a reading. Once the analyzer has taken its reading, a blast of compressed air is injected into the cup to blow and clear the material out of the cup, thereby allowing new material to fill the cup. Material can build up in the cup over time that can prevent new material from entering the cup which impedes the ability to measure the new material passing through the chute. In addition, fouling of the lens can occur as a thin layer of material accumulates over time on the lens.

In a typical cementitious board manufacturing process such as gypsum wallboard, cementitious board is produced by dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material (i.e., the face sheet) supported by a forming table. The foamed slurry is allowed to spread over the advancing face sheet. A second web of cover sheet material (i.e., the back sheet) is applied to cover the foamed slurry and form a sandwich structure of a continuous wallboard preform. The wallboard preform is subjected to forming, such as at a conventional forming station, to obtain a desired thickness.

The calcined gypsum reacts with the water in the wallboard preform to form a matrix of crystalline hydrated gypsum or calcium sulfate dihydrate and sets as a conveyor moves the wallboard preform down the manufacturing line. The hydration of the calcined gypsum provides for the formation of an interlocking matrix of set gypsum, thereby imparting strength to the gypsum structure in the gypsum-containing product. The product slurry becomes firm as the crystal matrix forms and holds the desired shape.

The quality of the calcined gypsum in terms of its phase composition of dihydrate, hemihydrate, and anhydrite (both soluble and insoluble) can have an influence on the crystalline matrix formation. The phase composition of the calcined gypsum may call for the adjustment of the concentration of one or more of the various additives known to for use in the board formulation.

After the wallboard preform is cut into segments downstream of the forming station at a point along the line where the preform has set sufficiently, the segments are flipped over, dried (e.g., in a kiln) to drive off excess water, and processed to provide the final wallboard product of desired dimensions. The aqueous foam produces air voids in the set gypsum, thereby reducing the density of the finished product relative to a product made using a similar slurry but without foam. Prior devices and methods for addressing some of the operational problems associated with the production of gypsum wallboard are disclosed in commonly-assigned U.S. Patent Nos. 5,683,635; 5,643,510; 6,494,609; 6,874,930; 7,007,914; and 7,296,919, which are incorporated by reference.

There is a continued need in the art to provide additional solutions to enhance the production of cementitious articles. For example, there is a continued need for techniques for producing calcined gypsum that yield a consistent proportion of hemihydrate in the output. As another example, there is a continued need for techniques for monitoring and controlling the production of calcined gypsum from a calciner that yields a consistent phase of calcium sulfate, such as hemihydrate. And for example, there is a continued need for techniques for monitoring the composition phases of calcined gypsum entering a board line mixer and adjusting and controlling the production formulation in response to the composition phases of such calcined gypsum.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a material handling chute assembly. In embodiments, a material handling chute assembly includes a chute and an analyzer configured to analyze at least one characteristic of the material passing through the chute.

In one embodiment, a material handling chute assembly includes a chute, a funnel assembly, and an analyzer. The chute includes an interior surface defining an interior passage through the chute. The funnel assembly is configured to define a converging sample passage disposed within the interior passage of the chute. The sample passage has an upstream open end and a downstream open end that is smaller than the upstream open end. The analyzer is arranged with the chute and configured to analyze at least one characteristic of the material passing through the funnel assembly in the chute.

In another aspect, the present disclosure is directed to embodiments of a system for manufacturing calcined gypsum. In embodiments, a system for manufacturing calcined gypsum includes a material handling chute assembly with a chute and an analyzer configured to analyze at least one characteristic of the material passing through the chute.

In one embodiment, a system for manufacturing calcined gypsum includes a calcination unit, a material handling chute assembly, and an in-line calcination control device. The calcination unit includes a calcining chamber and a heating unit associated with the calcining chamber. The calcining chamber includes an inlet for receiving a supply of gypsum therethrough and into the calcining chamber and an outlet for discharging the supply of gypsum from the calcining chamber.

The material handling chute assembly includes a chute and a funnel assembly. The chute is disposed in at least one of a position upstream of the inlet of the calcining chamber and a position downstream of the outlet of the calcining chamber. The chute includes an interior surface defining an interior passage through the chute. The funnel assembly is configured to define a converging sample passage disposed within the interior passage of the chute. The sample passage has an upstream open end and a downstream open end that is smaller than the upstream open end.

The in-line calcination control device includes an analyzer and a controller in operable arrangement therewith. The analyzer is arranged with the chute and configured to analyze at least one characteristic of gypsum passing through the funnel assembly in the chute. The analyzer is configured to generate a calcining control signal indicative of the at least one characteristic. The controller is configured to adjust at least one operating parameter of the calcination unit based upon the calcining control signal received from the analyzer.

In another aspect, the present disclosure describes embodiments of a method of manufacturing calcined gypsum. In embodiments, a method of manufacturing calcined gypsum includes varying at least one operating parameter based upon a data signal received from an analyzer analyzing at least one characteristic of material passing through a funnel assembly disposed within a chute.

In yet another aspect, the present disclosure is directed to embodiments of a system for manufacturing a gypsum board. In embodiments, a system for manufacturing a gypsum board includes a material handling chute assembly with a chute and an analyzer configured to analyze at least one characteristic of the calcined gypsum passing through the chute.

In one embodiment, a system for manufacturing a gypsum board includes a mixer, an ingredient supply system, a material handling chute assembly, and an in-line board control device.

The mixer is adapted to agitate calcined gypsum and water to form an aqueous gypsum slurry. The ingredient supply system is configured to selectively feed, according to a board formulation, at least water and calcined gypsum to the mixer. The ingredient supply system includes a source of calcined gypsum associated with the mixer to selectively deliver a feed stream of the calcined gypsum thereto.

The material handling chute assembly includes a chute and a funnel assembly. The chute includes an interior surface defining an interior passage through the chute. The chute is disposed between the source of calcined gypsum and the mixer such that the feed stream of calcined gypsum is configured to pass through the interior passage of the chute. The funnel assembly is configured to define a converging sample passage disposed within the interior passage of the chute. The sample passage has an upstream open end and a downstream open end that is smaller than the upstream open end.

The in-line board control device includes an analyzer and a controller in operable arrangement therewith. The analyzer is arranged with the chute and configured to analyze at least one characteristic of calcined gypsum passing through the funnel assembly in the chute. The analyzer is configured to generate a board control signal indicative of the at least one characteristic. The controller is configured to adjust at least one of the board formulation and a board line operational parameter based upon the board control signal received from the analyzer.

In still another aspect, the present disclosure describes embodiments of a method of manufacturing a gypsum board. In embodiments, a method of manufacturing a gypsum board includes varying at least one operating parameter based upon a data signal received from an analyzer analyzing at least one characteristic of calcined gypsum passing through a funnel assembly disposed within a chute.

Further and alternative aspects and features of the disclosed principles will be appreciated from the following detailed description and the accompanying drawings. As will be appreciated, the material handling chute assemblies and systems and techniques for manufacturing calcined gypsum and gypsum boards that are disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic view of an embodiment of a material handling chute assembly constructed in accordance with principles of the present disclosure.

FIG. 2 is a perspective view of an embodiment of a material handling chute assembly constructed in accordance with principles of the present disclosure, illustrating portions of a chute thereof in see-through form to illustrate an interior passage defined therein.

FIG. 3 is an elevational view, in section, of the material handling chute assembly of FIG. 2, illustrating a funnel assembly in a first operational position.

FIG. 4 is an elevational view, in section, of the material handling chute assembly of FIG. 2 as in FIG. 3 but illustrating the funnel assembly in a second operational position for clearing an obstruction in the funnel assembly.

FIG. 5 is a top plan view of the material handling chute assembly of FIG. 2, illustrating the funnel assembly in the first operational position shown in FIG. 3.

FIG. 6 is a top plan view of the material handling chute assembly of FIG. 2 as in FIG. 5 but illustrating the funnel assembly in the second operational position shown in FIG. 4.

FIG. 7 is a schematic plan diagram of an embodiment of a system for manufacturing calcined gypsum constructed in accordance with principles of the present disclosure and an embodiment of a system for manufacturing a gypsum board constructed in accordance with principles of the present disclosure that includes an embodiment of a gypsum slurry mixing and dispensing assembly constructed in accordance with principles of the present disclosure.

It should be understood that the drawings are not necessarily to scale and that the disclosed embodiments are illustrated diagrammatically and in partial views. In certain instances, details which are not necessary for an understanding of this disclosure or which render other details difficult to perceive have been omitted. It should be understood that this disclosure is not limited to the particular embodiments illustrated herein.

### DETAILED DESCRIPTION OF EXEMPLARY EMBODIMENTS

The present disclosure provides various embodiments of a material handling chute assembly suitable for use, e.g., in at least one of a system for manufacturing calcined gypsum and a system for manufacturing a gypsum board. In embodiments, the material handling chute assembly comprises a compact chute set up that is configured to provide a consistent, continuous steady flow of material past an associated analyzer to allow an analyzer to produce reliable measurement data with reduced operational variation. In embodiments, a suitable analyzer can be configured to analyze at least one characteristic of the material passing through the chute, such as, e.g., a reading for measuring gypsum / land plaster combined water and free moisture or stucco combined water.

In embodiments, the material handling chute assembly is configured to allow material being conveyed through a chute to be analyzed effectively by way of a funnel-like apparatus that collects and pools a sample portion of the material passing through the chute. An opening at the bottom of the funnel is configured to direct and control the flow of sample material through a sample passage defined by the funnel assembly so that the flow of sample material travels through an analyzer reading area of a suitable analyzer. The analyzer can be configured to analyze at least one characteristic of the material passing through the funnel assembly in the chute. The opening at the bottom of the funnel can be sized to allow less flow out of the funnel than the flow of sample material into the funnel. This allows the funnel to act as a reservoir to provide a reliable, substantially constant supply stream of sample material past the analyzer. Should the funnel assembly fill with sample material, additional flow of material can cause excess material beyond the funnel’s capacity to overflow an upstream opening of the funnel assembly and fall back into the chute for conveyance past the funnel assembly.

The present disclosure also provides various embodiments of a system and a method for at least one of manufacturing calcined gypsum and manufacturing a gypsum board that respectively include means and a step for analyzing gypsum to determine the proportion of at least one phase of calcium sulphate (dihydrate, hemihydrate, anhydrate) contained therein. Embodiments of systems and methods for manufacturing calcined gypsum and/or a gypsum board following principles of the present disclosure include a material handling chute assembly constructed according to principles of the present disclosure and an in-line control device having at least one analyzer arranged with the material handling chute assembly.

In embodiments, an analyzer is adapted to analyze at least one of: gypsum being fed into a calciner, calcined gypsum being discharged from a calciner, and calcined gypsum being fed into a mixer of a gypsum boardline. The analyzer is configured to determine the proportion of different calcium sulphate phases found therein which can be used to control at last one of the calciner and the boardline. In embodiments, the analyzer comprises at least one of a near infrared (NIR) analyzer and a x-ray analyzer configured to determine at least one characteristic of calcium sulphate. In embodiments, the analyzer comprises any suitable near infrared (NIR) analyzer or x-ray analyzer useful in determining at least one characteristic of calcium sulphate.

In embodiments, the means and step for analyzing gypsum can comprise equipment for using NIR absorption, x-ray diffraction (XRD), and/or x-ray florescence (XRF) to analyze a calcium sulfate specimen to measure the presence of different elements and/or molecular compounds as will be appreciated by one skilled in the art. The analysis can be used to determine the composition of materials in the gypsum.

In embodiments, the NIR analyzer comprises any suitable NIR analyzer useful in determining at least one characteristic of calcium sulphate using NIR spectroscopy. For example, in embodiments, the NIR analyzer comprises any commercially-available NIR analyzer suitable for use in measuring the free moisture of various material and/or measuring the combined water of gypsum in various forms including rock, land plaster, and stucco. In embodiments, the NIR analyzer includes an NIR light source and a detector configured to measure the response of the calcium sulphate specimen to the NIR light waves emitted from the NIR light source interacting with the calcium sulphate specimen. In embodiments, the NIR light source is configured to produce NIR light waves in a suitable NIR spectral range, such as, e.g., the spectrum between 750 nanometers and 2500 nanometers, and in some embodiments between 800 nanometers and 2500 nanometers.

In embodiments, the x-ray analyzer comprises any suitable x-ray analyzer useful in determining at least one characteristic of calcium sulphate. In embodiments, the x-ray analyzer includes an x-ray source and a detector configured to measure the response of the calcium sulphate specimen to the x-rays emitted from the x-ray source interacting with the calcium sulphate specimen.

In embodiments, the x-ray analyzer comprises any suitable XRD analyzer. In embodiments, the x-ray analyzer comprises an XRD analyzer configured to generate x-ray diffraction data that can be used to determine and measure the contents of calcium sulphate, including the proportion of at least one phase of calcium phosphate present in the specimen under analysis.

In embodiments, the x-ray analyzer comprises any suitable XRF analyzer. In embodiments, the x-ray analyzer comprises an XRF analyzer configured to generate x-ray fluorescence data that can be used to determine and measure the contents of calcium sulphate, including the proportion of at least one phase of calcium phosphate present in the specimen under analysis.

X-ray measurements can include known frequencies of peaks that indicate certain calcium sulfate derivates (among other elements and compounds). For example, CaSO₄∙2H₂O at 29.0, 31.0, and/or 33.3 degrees two theta; CaSO₄∙1/2H₂O at 29.4, 29.5, and/or 32.5 degrees two theta; CaSO₄O 25.4, and/or 25.5 degrees two theta. These peaks of interest may shift frequencies and/or amplitude when in the presence or absence of various compounds and/or elements.

Certain compounds, such as, salt (e.g., various chloride derivatives) can have a negative influence on calcination and board formation. In embodiments, the x-ray analyzer comprises an XRF analyzer configured to generate x-ray fluorescence data that can be used to determine whether an impurity is present in the calcium sulphate. In embodiments, the XRF analyzer is configured to measure the content of at least one of salt and chloride in the calcium sulphate being analyzed.

In embodiments, the calcination control device includes an in-line analyzer device configured to detect the amount of different phases of calcium sulphate present in a discharge stream from a calciner passing through a material handling chute assembly constructed according to principles of the present disclosure. In embodiments, the analyzer device can be used with any suitable calciner, such as those commercially available as readily appreciated by one skilled in the art. Examples of such calciners include commercially-available kettles and flash calciners with a bag house discharge.

In embodiments, an analyzer device is located downstream of the discharge of the calciner to monitor the discharge stream of material being discharged from the calciner and passing through a material handling chute assembly constructed according to principles of the present disclosure. In embodiments, the analyzer device is configured to detect the amounts of the following phases of calcium sulphate: dihydrate, hemihydrate, and anhydrate phases. A specially programmed processor can be configured to create a calcining control signal based upon information about the detected phase amounts contained in the x-ray diffraction data. The calcining control signal can be transmitted to a calcining controller which is configured to adjust at least one operating parameter of the calciner based upon the amount of different phases of calcium sulphate detected in the discharge stream, such as, e.g., the feed rate into the calciner and/or the temperature profile of the interior of the calciner. The analyzer device can be used to measure the content of dihydrate, hemihydrate, and anhydrate in the discharge stream from the calciner as part of a feedback loop for control of the calciner. In embodiments, the processor can be a part of the analyzer or the calcining controller or can comprise a part of both the analyzer and the calcining controller.

In embodiments, an analyzer device is located upstream of the inlet of the calciner to monitor the feed stream of gypsum being passing through a material handling chute assembly constructed according to principles of the present disclosure and then being fed into the calciner. The processor can be configured to calculate based upon the amounts of dihydrate, hemihydrate, and anhydrate detected by the analyzer device a calculated starting gypsum purity of the feed material fed into the calciner and a calculated target calcining profile of dihydrate, hemihydrate, and anhydrate. In embodiments, if the amount of anhydrate exceeds a threshold value (e.g., as compared to a calculated or predetermined target value), the calcining control signal generated by the processor can be configured for use by the calcining controller to direct the calciner to cook the feed material less by increasing the feed rate to the calciner and/or by reducing the heat profile of the calciner. If the amount of dihydrate exceeds a threshold value (e.g., as compared to a calculated or predetermined target value), the calcining control signal generated by the processor can be configured for use by the calcining controller to direct the calciner to cook the feed material more by decreasing the feed rate to the calciner and/or by increasing the heat profile of the calciner.

In embodiments, the processor can be configured to use predictive modeling using a database of historical measurement of material and calciner control points to generate the particular calcining control signal to affect the desired calciner control. In embodiments, a bias/re-calibration system can be provided that helps to maintain system measuring accuracy as changes in system or materials change the analyzer measuring signals. The bias/recalibration system can include sensor data to build a database and statistical model where a bias (offset) fact under various selected conditions can be determined and applied to the process control algorithm.

In embodiments, an analyzer device is located upstream of the feed inlet of the calciner to monitor the feed stream of material passing through a material handling chute assembly constructed according to principles of the present disclosure and being fed into the calciner. In embodiments, the analyzer device is configured to detect the amounts of the following phases of calcium sulphate in the feed stream: dihydrate, hemihydrate, and anhydrate phases. In embodiments, the analyzer device is configured to measure purity and at least one impurity of the feed stream (e.g., land plaster). In embodiments, the processor can be configured to calculate based upon the amounts of dihydrate, hemihydrate, and anhydrate detected by the analyzer device in the feed stream passing through a material handling chute assembly constructed according to principles of the present disclosure and the calciner’s set points (either as measured or as known by the set points inputted to the calciner), a calculated target calcining profile of dihydrate, hemihydrate, and anhydrate for the discharge stream. In embodiments, the processor can be configured to use analytic modeling to predict the target calcining profile (i.e., calculated amounts of dihydrate, hemihydrate, and anhydrate in the discharge stream) of the material discharged from the calciner based upon the amounts of dihydrate, hemihydrate, and anhydrate detected by the analyzer device in the feed stream passing through a material handling chute assembly constructed according to principles of the present disclosure and the calciner’s set points. In embodiments, the target calcining profile can be used by the calcining controller to control the calciner feed rate and/or heat input based upon the analyzer measurements of the material passing through a material handling chute assembly constructed according to principles of the present disclosure and fed into the calciner to form a feed forward loop. In embodiments, the use of the in-line analyzer device to measure different compositions of gypsum/stuccos can be used by the calcining controller to control the calciner to produce a discharge stream from the calciner meeting a specific quality parameter (e.g., a minimum percentage of hemihydrate in the discharge stream) and/or to reduce energy usage by the calciner to avoid using more energy than actually need to achieve a desired result.

In embodiments, an analyzer device is located in a material handling chute assembly constructed according to principles of the present disclosure located upstream of the mixer at a wet end of a gypsum manufacturing boardline to monitor the stucco composition being fed into the mixer. In embodiments, the analyzer (e.g., a suitable XRD analyzer or NIR analyzer) is preferably interposed between a stucco bin and the mixer. The analyzer device can be configured to monitor the composition of the stucco fed into the mixer. The detected amounts of dihydrate, hemihydrate, and anhydrate can be used by a boardline controller to control the board formulation. With the in-line analyzer device positioned to monitor the stucco stream being fed to the board mixer, it can provide real time monitoring of stucco quality, which, via a feed forward loop and analytical modeling performed by the processor, can be used by a boardline controller to automatically change the board formulation and/or at least one board line operational parameter. For example, the board formulation can be automatically controlled based upon the measurement data from the analyzer device monitoring the stucco feed stream by adjusting the amount of at least one of the water and one or more additives being fed to the board mixer. Examples of additives whose amounts can be adjusted by the boardline controller include one or more accelerators (e.g., a heat-resistant accelerator or land plaster accelerator), retarder, dispersant, soap, and starch. An example of a boardline operational parameter that can be adjusted by the boardline controller includes the board line speed. In embodiments, the use of the in-line analyzer device to monitor the stucco stream being fed through a material handling chute assembly constructed according to principles of the present disclosure and to the mixer can be used to enhance the usage of constituent materials comprising the board formulation to reduce raw material costs and/or reduce the occurrence of producing gypsum board that does not satisfy predetermined specifications.

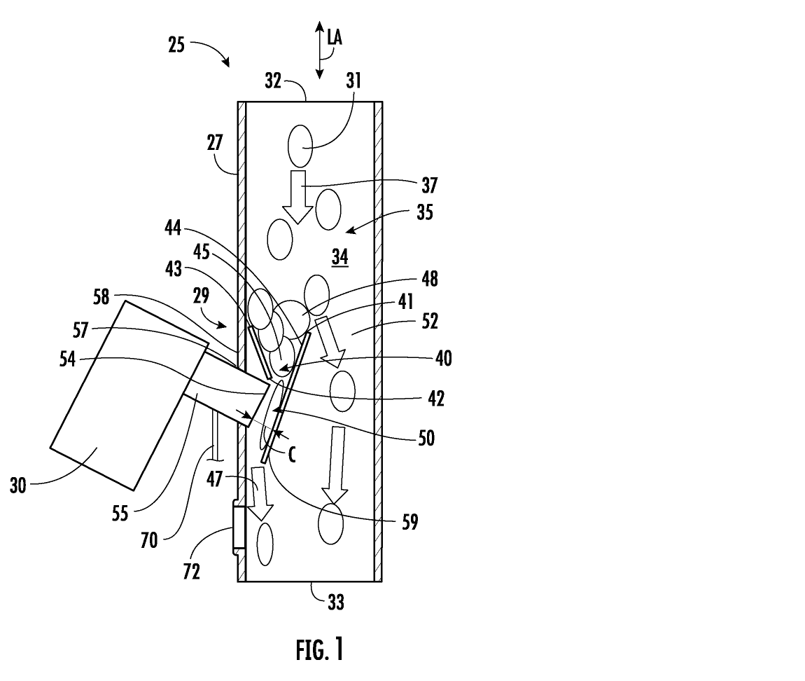

Turning now to the Figures, an embodiment is diagrammatically shown in FIG. 1 of a material handling chute assembly 25 constructed in accordance with principles of the present disclosure, which is suitable for use in, e.g., systems and methods for manufacturing calcined gypsum and for manufacturing a gypsum board. The material handling chute assembly 25 includes a chute 27 (shown in longitudinal section for illustrative purposes), a funnel assembly 29, and an analyzer 30.

The chute 27 is configured to provide an enclosure through which a flow of material 31 can be conveyed. The chute 27 is generally hollow with an upstream open end 32 and a downstream open end 33. The chute 27 includes an interior surface 34 defining an interior passage 35 through the chute 27 that is configured to permit the flow of material 31 (e.g., gypsum) to pass therethrough in a feed direction 37 from the upstream open end 32 toward the downstream open end 33.

The funnel assembly 29 is configured to define a converging sample passage 40 disposed within the interior passage 35 of the chute 27. The sample passage 40 has an upstream open end 41 and a downstream open end 42 that is smaller than the upstream open end 41.

In the illustrated embodiment, the funnel assembly 29 includes two funnel plates 43, 44: an upper funnel plate 43 and a lower funnel plate 44 that cooperate to form the V-shaped sample passage 40, which has a funnel arrangement within the interior passage 35 of the chute 27 through which a flow of sample material 45 can flow in a sample feed direction 47 from the upstream open end 41 to the downstream open end 42 of the sample passage 40, which is generally along the feed direction 37. In embodiments, the sample material 45 constitutes a portion of the material 31 passing through the interior passage 35 of the chute 27. In embodiments, the funnel plates 43, 44 are sufficiently wide (i.e., along an axis transverse to the plane depicted in FIG. 1) to allow adequate collection and pooling of sample material 45 within the sample passage 40 defined between the plates 43, 44.

The upper and lower funnel plates 43, 44 are arranged in a converging manner and can be disposed at any suitable angle relative to a longitudinal axis LA defined by the chute 27. For example, in embodiments, the upper and lower funnel plates 43, 44 are respectively disposed at an angle relative to the longitudinal axis LA to facilitate a collection of a sample material pool 48 within the funnel assembly 29 while still permitting the movement of the sample material 45 through the sample passage 40 defined by the funnel plates 43, 44. In some embodiments, the funnel plates 43, 44 are disposed no more than 20° degrees away from the longitudinal axis LA. In embodiments, the funnel plates 43, 44 can be disposed at substantially the same offset angle from the longitudinal axis LA at respective clockwise and counterclockwise outward orientations at the upstream open end 41 of the sample passage 40, as shown in FIG. 1.

The funnel plates 43, 44 are arranged above, in the direction of flow of sample material 45 from the upstream open end 41 to the downstream open end 42, the analyzer 30 such that the V-shaped sample passage 40 is configured to allow sample material 45 to flow though the downstream open end 42 at a controlled rate past an analyzer reading area 50 of the analyzer 30. The funnel plates 43, 44 are arranged and positioned to allow any overflow of sample material 52 from the sample material pool 48 and any oversized obstruction to pass laterally through the open sides of the sample passage 40, to thereby reduce the risk of material hanging up within the sample passage 40 of the funnel assembly 29.

The illustrated upper funnel plate 43 is disposed above, in the direction of flow of material from the upstream open end 41 to the downstream open end 42 of the sample passage 40, the analyzer 30. In embodiments, the upper funnel plate 43 can be curved or have angled uprights to better collect and pool sample material and direct sample material toward the lower funnel plate 44 by which sample material is conveyed past the analyzer 30.

The downstream open end 42 of the sample passage 40 of the funnel assembly 29 is configured to allow sample material to flow out towards the analyzer reading area 50 of the analyzer 30. In embodiments, the downstream open end 42 is defined and configured to direct and control the flow of sample material 45 through the sample passage 40 so that the flow of sample material 45 travels through the analyzer reading area 50 of the analyzer 30.

The lower funnel plate 44 extends longitudinally past the downstream open end 42 of the sample passage 40 of the funnel assembly 29 so that the flow of sample material 45 moving through the sample passage 40 follows along the lower funnel plate 44 past the analyzer reading area 50 of the analyzer 30. The funnel assembly 29 can be configured such that the sample material 45 sliding along the lower funnel plate 44 moves at a relatively slow exit rate through the analyzer reading area 50 past the analyzer 30 so that the analyzer 30 can measure at least one characteristic of the sample material 45. The slower rate of the flow of sample material 45 along the lower funnel plate 44 can reduce the incidence of material clouds forming between the bulk of the sample material 45 and the analyzer 30, thereby reducing the risk of analyzer signal fouling from low density material clouds.

The analyzer 30 is arranged with the chute 27 and is configured to analyze at least one characteristic of the material passing through the funnel assembly 29 in the chute 27. In embodiments, the analyzer 30 can be any suitable analyzer such as an NIR analyzer or an x-ray analyzer, for example. The analyzer 30 is mounted to the chute 27 at a distal end 54 of a tube 55 of the analyzer 30. The tube 55 extends through an opening 57 defined by a wall 58 of the chute 27 and into the interior passage 35, thereby allowing the analyzer 30 to be located outward of the interior passage 35 and away from the main flow of material 31 moving through the chute 27. The analyzer tube 55 can be mounted to the chute 27 by any suitable technique, such as by welding, for example, and positioned under the upper funnel plate 43. The distal end 54 of the tube 55, at which the analyzer 30 can be mounted, projects the interior passage 35. The distal end 54 of the tube 55 can be offset from the lower funnel plate 44 to define a clearance C therebetween through which sample material 45 moving through the sample passage 40 can move past the analyzer 30 and the bottom end 59 of the lower funnel plate 44 to rejoin the main flow of material 31 moving through the interior passage 35 and not through the sample passage 40 of the funnel assembly 29.

In embodiments, the tube 55 can be equipped with an airline 70 in fluid communication with a source of pressurized air that can be selectively operated to create positive pressure inside the tube 55 to thereby encourage air to move out of the tube 55. The positive air pressure can help to inhibit dust from accumulating in the reading area 50 of the analyzer 30 along the line of sight defined by the tube 55, and can inhibit dust from accumulating on the analyzer lens, thereby reducing the occurrence of analyzer reading fouling.

In embodiments, a sample port 72 can be provided through the wall 58 to allow material moving through the interior passage 35 to be tested to verify and/or calibrate the analyzer 30. In embodiments, the sample port 72 is positioned such as is shown in FIG. 1 to catch sample material 45 that passes through the sample passage 40 of the funnel assembly 29 past the analyzer 30.

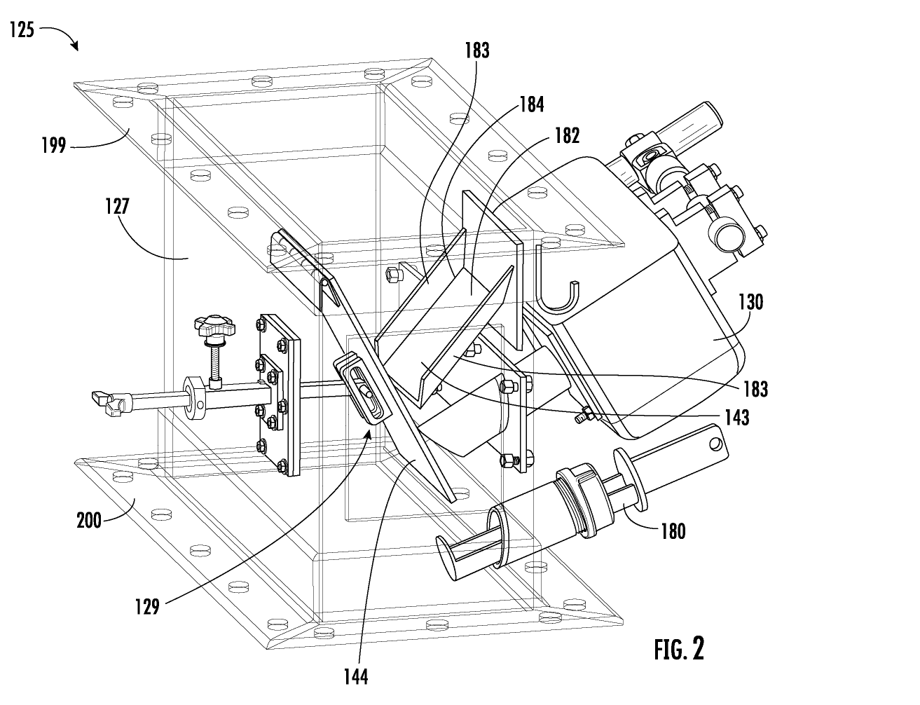

Referring to FIGS. 2-6, another embodiment of a material handling chute assembly 125 constructed in accordance with principles of the present disclosure is shown. The material handling chute assembly 125 includes a chute 127, a funnel assembly 129, an analyzer 130, and a sample catcher 180.

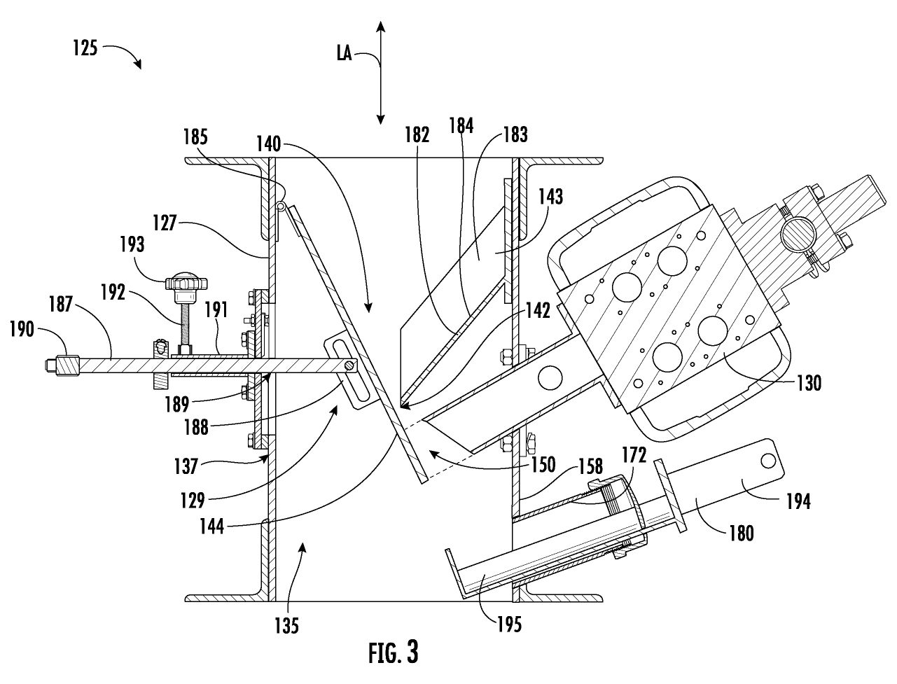

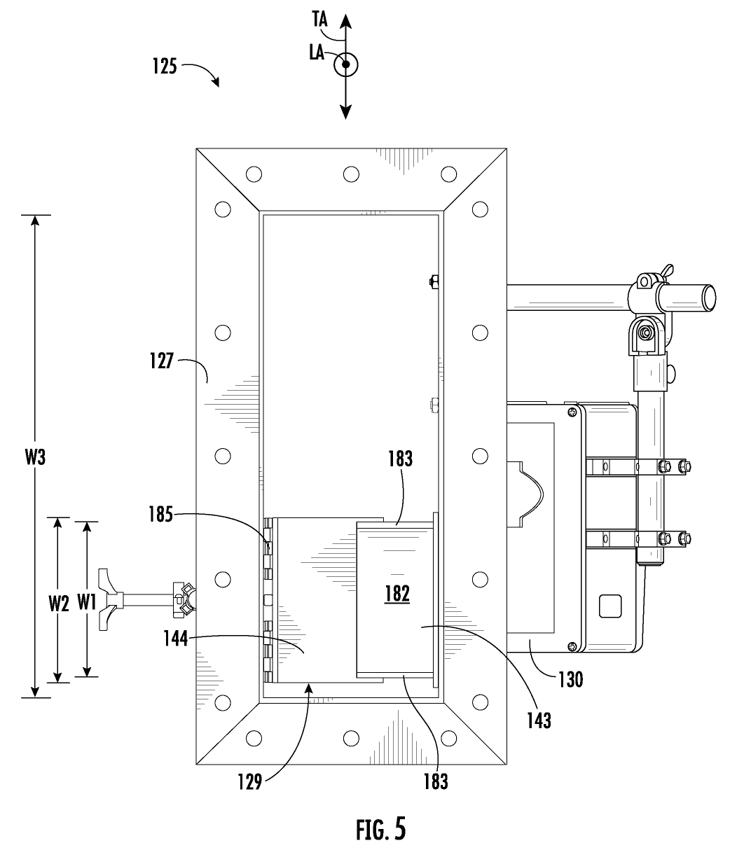

Referring to FIG. 3, the funnel assembly 129 includes two funnel plates 143, 144, an upper funnel plate 143 and a lower funnel plate 144, cooperating to form a V-shaped sample passage 140 having a funnel arrangement within the interior passage 135 of the chute 127 through which material flows. In embodiments, the upper funnel plate 143 is generally U-shaped in section. The illustrated upper funnel plate 143 is generally in the form of a block-shaped U section (see also FIGS. 2 and 5) and includes a base 182 and a pair of uprights 183 extending upwardly along the longitudinal axis LA respectively at each lateral end 184 of the base 182. In other embodiments, the upper funnel plate 143 can have a generally curved bottom base such that the upper funnel plate 143 is in the form of a curved U in section.

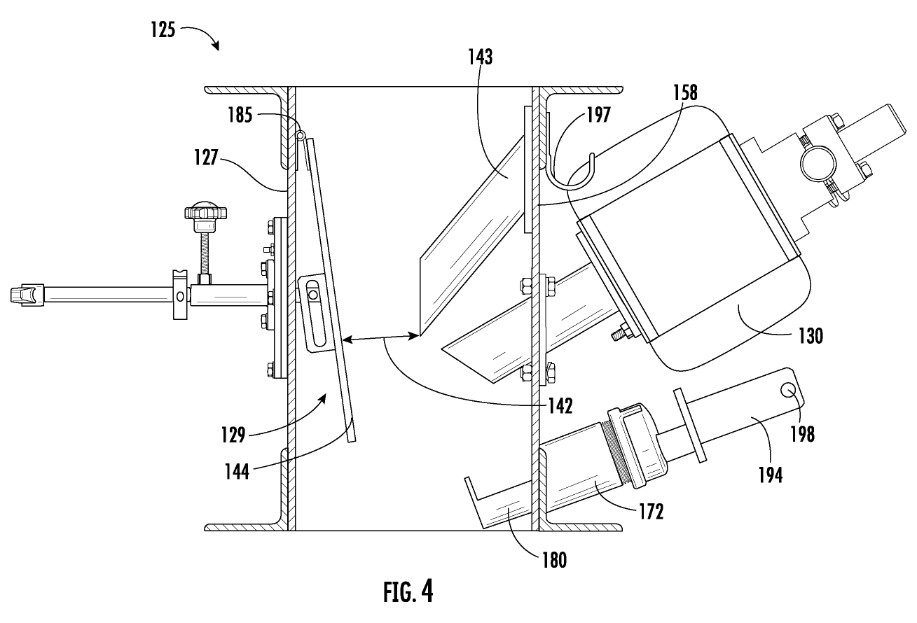

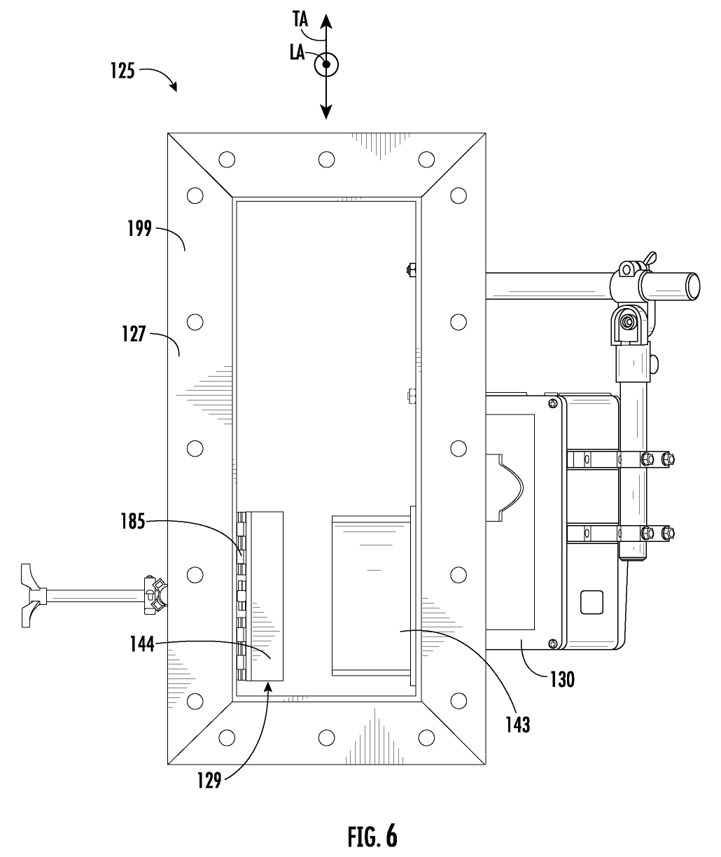

Referring to FIG. 3, the lower funnel plate 144 is pivotally mounted to the chute via a hinge 185 such that the lower funnel plate 144 is movable over a range of travel between a first operational position, as shown in FIG. 3, for normal operation wherein the downstream open end 142 of the sample passage 140 has a first size, and a second operational position, as shown in FIG. 4 and 6, for clearing an obstruction in the funnel assembly wherein the downstream open end 142 has a second size that is larger than the first size. In the event of an obstruction blocking material flow at the downstream open end 142 of the sample passage 140 defined by the funnel assembly 129, the lower funnel plate 144 can be moved to the second operational position to allow the obstruction to pass. Referring to FIG. 3, in embodiments, the lower funnel plate 144 can be selectively moved over the range of travel to modify the downstream open end 142 of the sample passage 140 defined by the funnel assembly 129 to control the flow rate of material past the analyzer reading area 150 of the analyzer 130.

In the illustrated embodiment, a control rod 187 is provided to selectively move the lower funnel plate 144 over the range of travel between the first and second operational positions. The control rod 187 is pivotally attached to a bracket 188 intermediately disposed along the lower funnel plate 144 and extends through an opening 189 in the chute 127 so that a proximal end 190 of the control rod 187 is disposed outwardly of the chute 127. Any suitable technique, as will be appreciated by one skilled in the art, can be used to move the control rod 187 along its axis to selectively move the lower funnel plate 144 over the range of travel between the first and second operational positions.

In the illustrated embodiment, the control rod 187 is disposed within a sleeve 191 mounted to the exterior surface 137 of the chute. A threaded stop 192 is threaded into the sleeve 191. The threaded stop 192 is rotatable in a first direction so that the stop 192 selectively engages the control rod 187 within the sleeve 191 to fix the control rod 187 in place and rotatable in a second direction to disengage the control rod 187 to permit it to be reciprocally moved along its axis to correspondingly move the lower funnel plate 144. The gripping wheel 193 of the stop 192 can be rotated so that the stop 192 selectively engages the control rod 187 within the sleeve 191 to fix the control rod 187 in place. The gripping wheel 193 can be rotated in the opposite direction to disengage the control rod 187 to permit it to be moved to correspondingly move the lower funnel plate 144.

In the illustrated embodiment, the chute 127 includes a wall 158 defining a sample port 172. In embodiments, the sample port 172 provided in the chute 127 can be configured to accommodate the sample catcher 180 as is shown in FIG. 3, for example. The sample catcher 180 includes a handle 194 and a sample collection trough 195 configured to be inserted into the interior passage 135 of the chute 127 via the sample port 180 and configured to collect a portion of the sample material passing through the sample passage 140 of the funnel assembly 129. The sample collection trough 195 has a U-Shaped cross section, which in embodiments can be a block-shaped U or a curved “U.” Referring to FIG. 4, a hang hook 197 can be mounted to the wall 158 of the chute 127 which is configured to fit through a mounting hole 198 defined in the handle 194 of the sample catcher 180 so that the sample catcher 180 is available for ready use when sampling material via the sample port 172

Referring to FIG. 5, the upper and lower funnel plates 143, 144 have a width W1, W2 that is respectively less than half the width W3 of the interior passage 135 of the chute 127, measured along the transverse axis TA, thereby facilitating the escape of overflow sample material from the sample passage. In other embodiments, the width of the funnel plates 143, 144 can be varied. In other embodiments, the lateral location of the upper and lower funnel plates 143, 144 within the interior passage 135 along the transverse axis TA can be varied. For example, the upper and funnel plates 143, 144 can be located at the lateral midpoint of the interior passage 135 along the transverse axis TA in other embodiments.

Referring to FIGS. 2 and 6, the material handling chute assembly 125 includes an upstream mounting flange 199 and a downstream mounting flange 200 to facilitate the inclusion of the material handling chute assembly 125 into a system for manufacturing calcined gypsum and a system for manufacturing a gypsum board constructed according to principles of the present disclosure. Both of the illustrated mounting flanges 199, 200 extend around the entire perimeter of the chute 127. In other embodiments, the mounting flanges 199, 200 can have a different configuration. The material handling chute assembly 125 of FIGS. 2-6 can be similar in other respects to the material handling chute assembly 25 of FIG. 1.

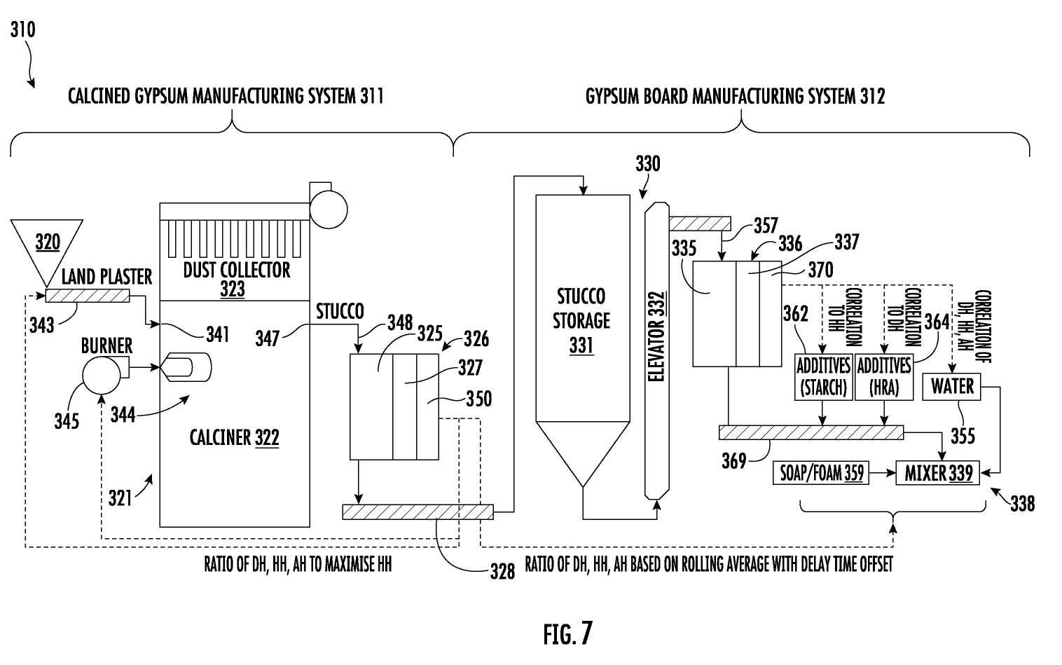

Referring to FIG. 7, an embodiment of a system 310 for manufacturing calcined gypsum and for manufacturing a gypsum board constructed in accordance with principles of the present disclosure is shown. The system 310 illustrated in FIG. 7 includes a system 311 for manufacturing calcined gypsum and a system 312 for manufacturing a gypsum board together to form an integrated manufacturing environment. In embodiments following principles of the present disclosure, a system for manufacturing calcined gypsum or a system for manufacturing gypsum board constructed according to principles of the present disclosure can be provided on its own.

The illustrated system 311 for manufacturing calcined gypsum includes a source of gypsum 320 in the form of land plaster powder, a calcination unit 321 comprising a calciner 322 with an associated dust collector 323, a first material handling chute assembly 325 constructed according to principles of the present disclosure with an in-line calcination control device 326 having a first analyzer 327, and a discharge conveyor 328. The illustrated system for manufacturing a gypsum board 312 includes an ingredient supply system 330 having a stucco bin 331 and an elevator 332, a second material handling chute assembly 335 constructed according to principles of the present disclosure with an in-line board formation control device 336 having a second analyzer 337, and a wet end assembly 338 that includes a mixer 339. It will be understood by one skilled in the art that the system 312 for manufacturing a gypsum board can include other known subsystems of a gypsum boardline that are not shown in FIG. 7, including, e.g., a forming station, a cutting station, a kiln, and suitable conveying equipment downstream of the wet end equipment shown in FIG. 7.

In embodiments, the source of gypsum 320 can be any suitable gypsum, such as, for example land plaster as illustrated in FIG. 7. In embodiments, the source of gypsum 320 is arranged with an inlet 341 of the calciner 322 to provide a feed stream of gypsum to the calciner 322. In the illustrated embodiment, the source of gypsum 320 is associated with a feeder conveyor 343 to selectively deliver the supply of gypsum powder to the calciner 322 via the feeder conveyor 343. The feeder conveyor 43 is configured to direct the feed stream from the source of gypsum 320 to a calcining chamber 344 of the calciner 322 via the inlet 341.

In embodiments, the calcination unit 321 includes the calcining chamber 344 and a heating unit 345 associated with the calcining chamber 344 for providing heat for calcination. The calcining chamber3 44 includes the inlet 341 for receiving a supply of gypsum therethrough and into the calcining chamber 344 and an outlet 347 for discharging a discharge stream 348 of calcined gypsum (generally referred to as “stucco”) from the calcining chamber 344.

In embodiments, the calcination unit 321 can comprise any suitable calcination unit, including any suitable commercially-available calciner as one skilled in the art would appreciate, such as, a suitable kettle or flash calciner, for example. Exemplary calcining units comprise kettles, which may be indirectly heated, roller mills, ball mills and hammer mills. In embodiments, the heating unit 345 of the calcination unit 321 includes at least one burner. Each burner can be operated using any suitable fuel, such as, for example, natural gas, petroleum gas, oil, coal, etc. Fuel and air can be introduced to each burner of the heating unit 345 to be burned and the hot gases are then provided in the calcining chamber 344.

The calcined gypsum can be ground or milled to a desired particle size range, which can be performed separately from calcination and can be performed before and/or after calcination. Milling and calcining may be performed in consecutive steps in different units or may be performed in one stage in a single unit. In embodiments a flash calcining unit can be used that performs steps of drying, grounding/milling, and calcining in a single stage in a single machine.

The dust collector 323 is arranged with the calciner 322 to collect dust emitted therefrom. In embodiments, the dust collector 323 can be any suitable dust collector suitable for abating the amount of dust emitted from the calciner 322.

The in-line calcination control device 326 includes the first analyzer 327 and a controller 350 in operable arrangement therewith. The first analyzer 327 is arranged with the chute of the first material handling chute assembly 325 and configured to analyze at least one characteristic of gypsum passing through the funnel assembly in the chute. The first material handling chute assembly 325 is arranged with the discharge stream 348 of the calciner 322 so that the discharge stream 348 is in fluid communication with the material handling chute assembly 325 so that the discharge stream 48 passes therethrough. In embodiments, the in-line calcination control device 326 is arranged so that the discharge stream 348 of the calciner 322 that passes through the funnel assembly within the material handling chute assembly 325 interacts with the first analyzer 327 of the in-line calcination control device 325 in a real-time manner and at a position after which the discharge stream 348 has been ground or milled to a desired particle size range. The first analyzer 327 is configured to generate a calcining control signal indicative of the at least one characteristic it analyzes.

The first analyzer 327 can be any suitable analyzer, such as any suitable NIR analyzer or x-ray analyzer, configured to analyze at least one characteristic of the material passing through the chute assembly 325. In embodiments, the material handling chute assembly 325 and the associated in-line calcination control device 326 is configured to analyze at least a portion of the supply of gypsum 320 in at least one of a position upstream of the inlet 341 of the calcining chamber 344 and a position downstream of the outlet 347 of the calcining chamber 344, such as is shown in FIG. 7.

The first analyzer 27 is configured to generate a calcining control signal indicative of the response measured by the detector of the analyzer. The controller 50 is configured to adjust at least one operating parameter of the calcination unit 21 based upon the calcining control signal received from the first analyzer 27.

In embodiments, the calcining control signal generated by the first analyzer 327 is indicative of the amounts of dihydrate, hemihydrate, and anhydrate phases in the supply of gypsum powder. In embodiments, the calcining control signal generated by the analyzer 327 is indicative of the purity of the supply of gypsum, including whether at least one impurity is present in the supply of gypsum. In embodiments, the calcining control signal generated is indicative of the contents of the supply of gypsum, including a proportion of at least one phase of calcium phosphate present in the supply of gypsum. In embodiments, the calcining control signal is indicative of the contents of the supply of gypsum powder, including whether an impurity is present in the supply of gypsum powder. In embodiments, the impurity comprises at least one of salt and chloride. In embodiments, the first analyzer 327 can comprise at least one of an NIR analyzer device, an XRD analyzer device, and an XRF analyzer device. In embodiments, the first analyzer 327 comprises two or more types of analyzer devices.

In embodiments, the first analyzer 327 is in electrical communication, via the controller 350, with the heating unit 345 of the calcination unit 321 and/or the feeder conveyor 343 to form a feedback control loop based upon the measured amounts of dihydrate, hemihydrate, and anhydrate in the discharge stream 348 from the calciner 322 according to principles discussed herein. In embodiments, the controller 350 is configured to adjust at least one of a feed rate of the supply of gypsum into the calcining chamber 344 and a temperature profile of the calcining chamber 344 based upon the calcining control signal received from the first analyzer 327. In embodiments, the controller 350 is configured to control at least one of the feeder conveyor 343 and the source of gypsum 320 to selectively adjust the feed rate of the supply of gypsum based upon the calcining control signal.

In embodiments, the feedback control loop provided by the first analyzer 327 can be used with a variety of calcium sulphate materials, to produce a discharge stream 348 from the calciner 322 comprising one or more of the following: water-soluble calcium sulfate anhydrite, calcium sulfate α-hemihydrate, calcium sulfate β-hemihydrate, natural, synthetic or chemically modified calcium sulfate hemihydrate, calcium sulfate dihydrate, and mixtures thereof. In one aspect, the discharge stream 348 desirably comprises calcined gypsum, such as in the form of calcium sulfate alpha hemihydrate, calcium sulfate beta hemihydrate, and/or calcium sulfate anhydrite. The calcined gypsum can be fibrous in some embodiments and nonfibrous in other embodiments. In embodiments, the calcined gypsum can include at least about 50% beta calcium sulfate hemihydrate. In other embodiments, the calcined gypsum can include at least about 86% beta calcium sulfate hemihydrate.

After calcination, the calcined gypsum can be discharged in the discharge stream 348 from the calcination unit 321 through the material handling chute assembly 325 to the discharge conveyor 328. In the illustrated embodiment, the discharge conveyor 328 transports the discharge stream 348 of calcined gypsum from the calcination unit 321 to the stucco bin 331. In other embodiments, the calcined gypsum can be transported directly to the boardline without passing through a stucco bin. The discharge stream 348 from the calciner 322 can be fed through the material handling chute assembly 325 to the stucco bin 331 (if present) for storage until the boardline calls for a supply of stucco. In the illustrated embodiment, the first analyzer 327 is located downstream of the outlet 347 of the calcining chamber 344 and is configured to monitor at least a portion of the discharge stream 348 of calcined gypsum being discharged from the calcination unit 321.

In embodiments, the ingredient supply system 330 is configured to selectively feed, according to a board formulation, at least water 355 and a feed stream 357 of calcined gypsum to at least one inlet of the mixer 339. The illustrated ingredient supply system 330 includes a source of calcined gypsum 331 associated with the mixer 339 to selectively deliver the feed stream 357 of calcined gypsum to at least one inlet of the mixer 339, and a source of water 355, a source of soap/foam 359, a source of starch 362, and a source of heat-resistant accelerator 364 each associated with the mixer 339 to selectively deliver them, respectively, to at least one inlet of the mixer 339. The ingredient supply system 330 can include a foam generator system suitable for delivering the supply of foam 359 to the mixer 339 and/or discharge conduit of the mixer 339 as is well understood by one skilled in the art. In embodiments, two or more ingredients can be delivered to the mixer 339 via a common inlet. In other embodiments, the ingredient supply system 330 can include any suitable dry ingredient and/or suitable liquid ingredient as will be appreciated by one skilled in the art.

The illustrated ingredient supply system 330 includes the stucco bin 331 and the elevator 332. The stucco bin 331 can be associated with the elevator 332 in order to selectively supply the wet end assembly 338 with the feed stream 357 of calcined gypsum. The elevator 332 is disposed between the stucco bin 331 and the second analyzer 337. The elevator 332 is configured to receive the feed stream 357 of calcined gypsum from the stucco bin 331, convey the feed stream 357 of calcined gypsum from the stucco bin 331 to an elevated position, and discharge the feed stream 357 of calcined gypsum therefrom so that the feed stream 357 can be conveyed through the material handling chute assembly 335 to the mixer 339 via the effect of gravity upon it. In embodiments, the ingredient supply system 330 can include a suitable device 369 such as an auger, screw, or similar device for incorporating the feed stream 357 of calcined gypsum and at least one other ingredient of the board formulation together for introduction into the mixer 339 and appropriate conveyor and/or ductwork for facilitating the conveyance of at least one ingredient to an inlet of the mixer. In the illustrated embodiment, the material handling chute assembly 335 is disposed between the elevator 32 and the auger 369.

The in-line board control device 336 includes the second analyzer 337 configured to analyze at least one characteristic of calcined gypsum passing through the second chute assembly 335 and a controller 370 in operable arrangement therewith. The second analyzer 337 is arranged with the chute of the second material handling assembly 335 and configured to analyze at least one characteristic of calcined gypsum passing through the funnel assembly in the chute. The second analyzer 337 is configured to generate a board control signal indicative of the at least one characteristic measured by the detector of the analyzer. The controller 370 is configured to adjust at least one of the board formulation and a board line operational parameter based upon the board control signal received from the second analyzer 337.

In embodiments, the board control signal generated by the second analyzer 337 is indicative of the amounts of dihydrate, hemihydrate, and anhydrate phases in the feed stream of calcined gypsum. In embodiments, the board control signal generated by the second analyzer 337 is indicative of the purity of the feed stream of calcined gypsum, including whether at least one impurity is present in the feed stream 357 of calcined gypsum.

The second analyzer 337 is preferably disposed downstream of the elevator and is arranged to monitor the stucco stream being fed to the wet end assembly 338, in particular the mixer 339 of the wet end assembly 338. In embodiments, the wet end assembly 338 can include any suitable equipment adapted to mix and/or assemble the constituent materials forming the gypsum board.

In embodiments, the second analyzer 337 can comprise at least one of an NIR analyzer device, an XRD analyzer device, and an XRF analyzer device. The second analyzer 337 is in electrical communication with the boardline controller 370 which is configured to regulate the board formulation and the operation of boardline equipment, including the ingredient supply system 330, the mixer 339, and the foam injection system 359.

In embodiments, the board control signal is indicative of the contents of the feed stream of calcined gypsum, including a proportion of at least one phase of calcium phosphate present in the feed stream of calcined gypsum. In embodiments, the board control signal is indicative of the contents of the feed stream of calcined gypsum, including whether an impurity is present in the feed stream of calcined gypsum. In embodiments, the impurity comprises at least one of salt and chloride.

In embodiments, the second analyzer 337 is in electrical communication with the boardline controller 370 to form a forward control loop based upon the measured amounts of dihydrate, hemihydrate, and anhydrate in the stucco stream being fed to the mixer. For example, the amount of starch in the board formulation can be regulated according to the amount of hemihydrate detected in the stucco stream. The amount of accelerator in the board formulation can be adjusted according to the amount of dihydrate detected in the stucco stream. The amount of water in the board formulation can be adjusted according to the proportional amounts of dihydrate, hemihydrate, and anhydrate detected in the stucco stream.

In embodiments, the second analyzer 337 can be used by the processor of the second analyzer to determine whether the stucco stream contains an amount of salt and/or chloride. The second analyzer 337 can send a board control signal to the boardline controller 370 in the event that salt/chloride is detected in the stucco stream to the mixer 339 over a certain threshold to regulate the operation of the foam injection system 359 arranged with the mixer 339 and/or the discharge conduit thereof.

The mixer 339 is adapted to agitate the feed stream 357 of calcined gypsum, the water 355, and other known additives supplied by the ingredient supply system 330 to form an aqueous gypsum slurry which is configured to form the core of the gypsum board. In embodiments, the mixer 339 includes a housing and an agitator disposed within the housing. The agitator can be configured to agitate water and calcined gypsum to form an aqueous gypsum slurry. In embodiments, the housing has at least one inlet for delivering the water and the calcined gypsum to the mixer 339 and an outlet for discharging the aqueous gypsum slurry from the housing of the mixer 339.

In embodiments, the housing defines a mixing chamber, a water inlet, and a calcined gypsum inlet. The water inlet and the calcined gypsum inlet are in communication with the mixing chamber. In embodiments, the housing defines a plurality of water inlets that are arranged near the calcined gypsum inlet. In embodiments, the housing defines one or more other water inlets located closer to the radial periphery of the housing. In embodiments, the housing defines at least one additive inlet for receiving an additive therethrough.

In embodiments, the mixer 339 is in fluid communication with a discharge conduit and the foam injection system 359. Both the water and the stucco stream can be supplied to the mixer 339 via one or more inlets as is known in the art. In embodiments, any other suitable slurry additive can be supplied to the mixer 339. The weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.as is known in the art of manufacturing cementitious products.

In embodiments, one or more inlets can be provided for introducing other additives into the mixer 339 in addition to foam that are commonly used in the production of gypsum board. Such additives include structural additives including mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, hydrophobic agent, such as a silicone-based material (e.g., a silane, siloxane, or silicone-resin matrix), and the like. Examples of the use of some of these and other additives are described, for instance, in U.S. Patent Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

In embodiments, the in-line calcination control device 326 and the in-line board formation control device 336 can include a processor and a non-transitory computer readable medium bearing a calciner control application and a boardline control application, respectively. In embodiments, each of the first analyzer 327 and the second analyzer 337 includes the processor and the non-transitory computer readable medium bearing the calciner control application and the boardline control application, respectively. In other embodiments, each of the calcining controller 350 and the boardline controller 370 includes the processor and the non-transitory computer readable medium bearing the calciner control application and the boardline control application, respectively. In other embodiments, the processor respectively comprises a part of the first analyzer 327 and the second analyzer 337 and the respective controller 350, 370. In embodiments, the in-line calcination control device 326 and the in-line board formation control device 336 can comprise an integrated device configured to perform both calciner control operations and boardline control operations, positioned at a point between the calciner and the mixer.

The processor is in communication with the associated analyzer device(s) 327, 337 to receive the measurement data therefrom. In embodiments, the processor is programmed with at least one of the particular control applications.

In embodiments, the in-line calcination control device 326 and the in-line board formation control device 336 can include a user input and/or interface device having one or more user-actuated mechanisms (e.g., one or more push buttons, slide bars, rotatable knobs, a keyboard, and a mouse) adapted to generate one or more user actuated input control signals. In embodiments, the in-line calcination control device 326 and the in-line board formation control device 336 can be configured to include one or more other user-activated mechanisms to provide various other control functions for the calciner and/or boardline, as will be appreciated by one skilled in the art. The in-line calcination control device 326 and the in-line board formation control device 336 can include a display device adapted to display a graphical user interface. The graphical user interface can be configured to function as both a user input device and a display device in embodiments. In embodiments, the display device can comprise a touch screen device adapted to receive input signals from a user touching different parts of the display screen. In embodiments, processor of the in-line calcination control device 326 and/or the in-line board formation control device 336 can be in the form of a smart phone, a tablet, a personal digital assistant (e.g., a wireless, mobile device), a laptop computer, a desktop computer, or other type of device. In embodiments, the processor of the in-line calcination control device 326 and the in-line board formation control device 336 can comprise the same device or be formed from a set of equipment.

In embodiments, the processor is in operable arrangement with the non-transitory computer-readable medium to execute the control application contained thereon. The processor can be in operable arrangement with a display device to selectively display output information from the control application and/or to receive input information from a graphical user interface displayed by the display device.

In embodiments, the processor can comprise any suitable computing device, such as, a microprocessor, a mainframe computer, a digital signal processor, a portable computing device, a personal organizer, a device controller, a logic device (e.g., a programmable logic device configured to perform processing functions), a digital signal processing (DSP) device, or a computational engine within an appliance. In embodiments, the processor also includes one or more additional input devices (e.g., a keyboard and a mouse).

The processor can have one or more memory devices associated therewith to store data and information. The one or more memory devices can include any suitable type, including volatile and non-volatile memory devices, such as RAM (Random Access Memory), ROM (Read-Only Memory), EEPROM (Electrically-Erasable Programmable Read-Only Memory), flash memory, etc. In one embodiment, the processor is adapted to execute programming stored upon a non-transitory computer readable medium to perform various methods, processes, and modes of operations in a manner following principles of the present disclosure.

In embodiments, the non-transitory computer readable medium can contain a control application that is configured to implement an embodiment of a method for manufacturing calcined gypsum and/or manufacturing gypsum board according to principles of the present disclosure. In embodiments, the control application includes a graphical user interface that can be displayed by the display device. The graphical user interface can be used to facilitate the inputting of commands and data by a user to the control application and to display outputs generated by the control application.

The control application can be stored upon any suitable computer-readable storage medium. For example, in embodiments, a control program following principles of the present disclosure can be stored upon a hard drive, floppy disk, CD-ROM drive, tape drive, zip drive, flash drive, optical storage device, magnetic storage device, and the like.

In embodiments, any suitable mixer (e.g., a pin mixer) can be used in the wet end. In embodiments, the mixer can be a suitable, commercially-available mixer, as is known in the gypsum board manufacturing art, such as, one available from Gypsum Technologies Inc. or John Broeders Machine both of Ontario, Canada, for example.

In embodiments, the agitator is rotatably mounted within the mixing chamber. The agitator can include a radially extending disc to which is attached a generally vertical drive shaft positioned along a normal axis, which is perpendicular to both a machine direction and a cross-machine direction. The drive shaft can extend through the upper wall of the main mixer. The drive shaft can be connected to a conventional drive source, such as, a motor, for example, for rotating the drive shaft at a suitable speed (e.g., 275-300 rpm) appropriate for rotating the agitator to mix the contents of the mixing chamber of the main mixer. This rotation directs the resulting aqueous slurry in a generally centrifugal direction, such as in a clockwise outward spiral. It should be appreciated that this discussion of an agitator is meant only to indicate the basic principles of agitators commonly employed in gypsum slurry mixing chambers known in the art. Alternative agitator designs, including those employing pins, paddles, plows, rings, etc., are contemplated.

In embodiments, the weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.

In embodiments, a slurry discharge conduit is provided that is in fluid communication with the main mixer. In embodiments, the slurry discharge conduit can comprise any suitable discharge conduit component as will be appreciated by one skilled in the art. For example, the discharge conduit can include a delivery conduit, a foam injection body of the foam injection system, a flow-modifying element, and a slurry distributor.

In embodiments, the discharge conduit is in fluid communication with the main mixer and is configured to deliver a main flow of the core slurry from the main mixer downstream to a further manufacturing station. In embodiments, the discharge conduit is adapted to deposit the core slurry upon a web of cover sheet material advancing in a machine direction. In this arrangement, the gypsum board is produced “face down” such that the advancing web serves as the “face” cover sheet of the finished board. In embodiments, the core slurry can be discharged from the discharge conduit in an outlet flow direction substantially along the machine direction in which the moving face cover sheet is travelling.

In embodiments, the delivery conduit can be made from any suitable material and can have different shapes. In some embodiments, the delivery conduit can comprise a flexible conduit.

In embodiments, one or more flow-modifying elements can be associated with the discharge conduit and adapted to modify the flow of the core slurry discharged from the main mixer through the discharge conduit. In embodiments, the flow-modifying element is disposed downstream of the foam injection body and the aqueous foam supply conduit relative to a flow direction of the flow of cementitious slurry from the main mixer through the discharge conduit. The flow-modifying element(s) can be used to control an operating characteristic of the flow of the core slurry moving through the discharge conduit. Examples of suitable flow-modifying elements include volume restrictors, pressure reducers, constrictor valves, canisters etc., including those described in U.S. Patent Nos. 6,494,609; 6,874,930; 7,007,914; and 7,296,919, for example.

In embodiments, the slurry distributor can be any suitable terminal portion of a conventional discharge conduit, such as a length of conduit in the form of a flexible hose or a component commonly referred to as a “boot.” In embodiments, the boot can be in the form of a multi-leg discharge boot.

In yet other embodiments, the slurry distributor of the discharge conduit can be similar to one as shown and described in U.S. Patent Application Publication Nos. 2012/0168527; 2012/0170403; 2013/0098268; 2013/0099027; 2013/0099418; 2013/0100759; 2013/0216717; 2013/0233880; and 2013/0308411, for example. In some of such embodiments, the discharge conduit can include suitable components for splitting a main flow of cementitious slurry from the main mixer into two flows which are re-combined in the slurry distributor.

In embodiments, a foam injection system is arranged with at least one of the main mixer and the slurry discharge conduit. The foam injection system can include a foam source (e.g., such as a foam generation system configured as known in the art), a foam supply conduit, and a suitable foam injection body.

In embodiments, any suitable foam source can be used. Preferably, the aqueous foam is produced in a continuous manner in which a stream of a mix of foaming agent and water is directed to a foam generator, and a stream of the resultant aqueous foam leaves the generator and is directed to and mixed with the cementitious slurry. In embodiments, any suitable foaming agent can be used. Some examples of suitable foaming agents are described in U.S. Patent Nos. 5,683,635 and 5,643,510, for example.

In embodiments, the aqueous foam supply conduit can be in fluid communication with at least one of the main mixer and the delivery conduit. An aqueous foam from the foam source can be added to the constituent materials through the foam supply conduit at any suitable location downstream of the main mixer in the discharge conduit and/or in the main mixer itself to form a foamed cementitious slurry. In the illustrated embodiment, the foam supply conduit is disposed downstream of the main mixer. In embodiments, the aqueous foam supply conduit has a manifold-type arrangement for supplying foam to a number of foam injection ports within the foam injection body, which can be in the form of an injection ring or block, associated with the discharge conduit, such as is described in U.S. Patent No. 6,874,930, for example.

In other embodiments, one or more secondary foam supply conduits can be provided, and each of which is in fluid communication with the main mixer. In yet other embodiments, the aqueous foam supply conduit(s) can be in fluid communication with the main mixer alone. As will be appreciated by those skilled in the art, the means for introducing aqueous foam into the gypsum slurry, including its relative location in the assembly, can be varied and/or optimized to provide a uniform dispersion of aqueous foam in the core slurry to produce board that is fit for its intended purpose.

In embodiments, the foam injection body comprises a part of at least one of the main mixer and the slurry discharge conduit. The illustrated foam injection body comprises a part of the discharge conduit.

In embodiments, one or both of the cover sheets of the gypsum board can be treated with a relatively denser layer of gypsum slurry (relative to the core slurry from which the board core is made), often referred to as a “skim coat” in the art, if desired. To that end, in embodiments, the main mixer can include an auxiliary conduit that is adapted to deposit a stream of dense aqueous cementitious slurry that is relatively denser than the core slurry deposited from the discharge conduit. In embodiments, the denser layer can be provided at the edges of the board, as well, using known equipment and techniques.

In embodiments, the auxiliary conduit comprises one for depositing a skim coat layer to a back cover sheet. The main mixer can direct a flow of aqueous calcined gypsum slurry through the auxiliary conduit (i.e., a “back skim coat stream”) that is relatively denser than the main flow of the foamed core slurry dispensed from the discharge conduit. A back skim coat station can include suitable equipment for applying the back skim coat, such as, for example, a back skim coat roller disposed over a support element such that the second cover sheet being dispensed from a second roll is disposed therebetween. The auxiliary conduit can deposit the back skim coat stream upon the moving second cover sheet upstream (in the direction of movement of the second cover sheet) of the back skim coat roller that is adapted to apply a skim coat layer to the second cover sheet being dispensed from the second roll as is known in the art.

In other embodiments, separate auxiliary conduits can be connected to the main mixer to deliver one or more separate streams to the face cover sheet. Other suitable equipment (such as auxiliary mixers) can be provided in the auxiliary conduits to help make the slurry therein denser, such as by mechanically breaking up foam in the slurry and/or by chemically breaking up the foam through use of a suitable de-foaming agent inserted into the auxiliary conduit(s) through a suitable inlet. In other embodiments, an auxiliary conduit can direct slurry from the main mixer into a second mixer and/or include a suitable inlet for incorporating at least one enhancing additive therein to form a strengthened slurry having at least one ingredient which is more concentrated in the strengthened slurry than in the core slurry to form a slurry suitable for use as a concentrated layer and/or as edge layer(s).

In embodiments, the wet end assembly can be equipped with other conventional equipment as is known in the art. The wet end assembly is configured to mix and assemble constituent materials together such that a continuous gypsum board having a predetermined nominal thickness can be produced from a forming station along a conveyor in the machine direction toward a cutting station. In embodiments, the system for manufacturing a gypsum board can include other components and stations. For example, in embodiments, the system can include a transfer system, including a board inverter; a kiln; and a bundler and taping station, all downstream of the cutting station. In embodiments, the board manufacturing process can be completed using any suitable techniques and equipment which are known to those skilled in the art.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A material handling chute assembly comprising:
a chute, the chute includes an interior surface defining an interior passage through the chute;
a funnel assembly, the funnel assembly being configured to define a converging sample passage disposed within the interior passage of the chute, the sample passage having an upstream open end and a downstream open end that is smaller than the upstream open end; and
an analyzer, the analyzer being arranged with the chute and configured to analyze at least one characteristic of material passing through the funnel assembly in the chute.

2. The material handling chute assembly of claim 1, wherein the funnel assembly includes an upper funnel plate and a lower funnel plate that cooperate to form a V-shaped sample passage.

3. The material handling chute assembly of claim 2, wherein the downstream open end is configured to direct and control flow of material through the sample passage so that the flow of material travels through an analyzer reading area of the analyzer.

4. The material handling chute assembly of claim 2, wherein the upper and lower funnel plates are arranged and positioned to allow any overflow of pooled material and any oversized obstruction to pass laterally through the open sides of the sample passage.

5. The material handling chute assembly of claim 4, wherein the upper and lower funnel plates are each less than half the width of the interior passage of the chute.

6. The material handling chute assembly of claim 2, wherein the upper funnel plate is disposed above, in the direction of flow of material from the upstream open end to the downstream open end, the analyzer.

7. The material handling chute assembly of claim 6, wherein the upper funnel plate is generally U-shaped in section.

8. The material handling chute assembly of claim 7, wherein the upper funnel plate includes a base with a pair of lateral ends and a pair of uprights extending upwardly along the longitudinal axis respectively at each lateral end of the base.

9. The material handling chute assembly of claim 2, wherein the upper and lower funnel plates are arranged above, in the direction of flow of material from the upstream open end to the downstream open end, the analyzer such that the V-shaped sample passage is configured to allow material to flow though the downstream open end at a controlled rate past an analyzer reading area of the analyzer.

10. The material handling chute assembly of claim 9, wherein the lower funnel plate extends longitudinally past the downstream open end so that the flow of material through the sample passage follows along the lower funnel plate past the analyzer reading area of the analyzer.

11. The material handling chute assembly of claim 9, wherein the lower funnel plate is pivotally mounted to the chute via a hinge such that the lower funnel plate is movable over a range of travel between a first operational position wherein the downstream open end has a first size and a second operational position wherein the downstream open end has a second size, the second size being larger than the first size.

12. The material handling chute assembly of claim 11, wherein the funnel assembly includes a control rod pivotally attached to a bracket intermediately disposed along the lower funnel plate and extending through an opening in the chute so that a proximal end of the control rod is disposed outwardly of the chute.

13. The material handling chute assembly of claim 12, wherein the control rod is disposed within a sleeve mounted to the exterior surface of the chute and a threaded stop is threaded into the sleeve, the threaded stop being rotatable in a first direction so that the stop selectively engages the control rod within the sleeve to fix the control rod in place and rotatable in a second direction to disengage the control rod to permit it to be moved to correspondingly move the lower funnel plate.

14. The material handling chute assembly of claim 1, wherein the analyzer is configured to determine the proportion of at least one phase of calcium phosphate found in the flow of material.

15. The material handling chute assembly of claim 1, wherein the analyzer comprises at least one of a near infrared (NIR) analyzer and a x-ray analyzer configured to determine at least one characteristic of calcium sulphate.

16. The material handling chute assembly of claim 1, wherein the chute includes a wall defining an opening through the wall, and the analyzer includes a tube having a distal end, the analyzer being mounted to the chute at the distal end of the tube, the tube extending through the opening of the wall of the chute into the interior passage.

17. The material handling chute assembly of claim 16, wherein the tube is equipped with an airline in fluid communication with a source of pressurized air selectively operable to create positive pressure inside the tube to thereby encourage air to move out of the tube.

18. The material handling chute assembly of claim 1, wherein the chute includes a wall defining a sample port, and the material handling chute assembly further comprising:
a sample catcher, the sample catcher including a handle and a sample collection trough configured to be inserted into the interior passage of the chute via the sample port.

19. A system for manufacturing calcined gypsum comprising:
a calcination unit, the calcination unit including a calcining chamber and a heating unit associated with the calcining chamber, the calcining chamber having an inlet for receiving a supply of gypsum therethrough and into the calcining chamber and an outlet for discharging the supply of gypsum from the calcining chamber;
a material handling chute assembly, the material handling chute assembly including a chute and a funnel assembly, the chute being disposed in at least one of a position upstream of the inlet of the calcining chamber and a position downstream of the outlet of the calcining chamber, the chute having an interior surface defining an interior passage through the chute, the funnel assembly being configured to define a converging sample passage disposed within the interior passage of the chute, the sample passage having an upstream open end and a downstream open end that is smaller than the upstream open end; and
an in-line calcination control device, the in-line calcination control device including an analyzer and a controller in operable arrangement therewith, the analyzer being arranged with the chute and configured to analyze at least one characteristic of gypsum passing through the funnel assembly in the chute, the analyzer being configured to generate a calcining control signal indicative of the at least one characteristic, the controller being configured to adjust at least one operating parameter of the calcination unit based upon the calcining control signal received from the analyzer.

20. A system for manufacturing a gypsum board comprising:
a mixer, the mixer being adapted to agitate calcined gypsum and water to form an aqueous gypsum slurry;
an ingredient supply system, the ingredient supply system being configured to selectively feed at least water and calcined gypsum to the mixer, the ingredient supply system including a source of calcined gypsum associated with the mixer to selectively deliver a feed stream of the calcined gypsum thereto;
a material handling chute assembly, the material handling chute assembly including a chute and a funnel assembly, the chute having an interior surface defining an interior passage through the chute, the chute being disposed between the source of calcined gypsum and the mixer such that the feed stream of calcined gypsum is configured to pass through the interior passage of the chute, the funnel assembly being configured to define a converging sample passage disposed within the interior passage of the chute, the sample passage having an upstream open end and a downstream open end that is smaller than the upstream open end;
an in-line board control device, the in-line board control device including an analyzer and a controller in operable arrangement therewith, the analyzer being arranged with the chute and configured to analyze at least one characteristic of calcined gypsum passing through the funnel assembly in the chute, the analyzer being configured to generate a board control signal indicative of the at least one characteristic, the controller being configured to adjust at least one of a board formulation and a board line operational parameter based upon the board control signal received from the analyzer.
